(19) United States
(12) Patent Application Publication
(10) Pub. No.: US 2015/0142192 A1
(43) Pub. Date: May 21, 2015

(54) METHOD OF REGULATING A PLANT COMPRISING COGENERATING INSTALLATIONS AND THERMODYNAMIC SYSTEMS INTENDED FOR AIR CONDITIONING AND/OR HEATING

(71) Applicant: Mobile Comfort Holding, Neyron (FR)

(72) Inventor: Christian Moreau, Neyron (FR)

(21) Appl. No.: 14/405,477

(22) PCT Filed: Jun. 4, 2013
(86) PCT No.: PCT/FR2013/051257

§ 371 Date: Dec. 4, 2014

(30) Foreign Application Priority Data
Jun. 4, 2012 (FR) 1255175

(51) Int. Cl. G05D 23/19; G05F 1/66; G05B 15/02

(52) U.S. Cl. CPC G05D 23/1923; G05B 15/02; G05F 1/66
USPC 700/288

(57) ABSTRACT

A method of regulating an installation associating one or several cogeneration machines and one or several thermodynamic systems (e.g., air conditioner (whether or not reversible), water cooler or heat pump (whether or not reversible)) intended for air conditioning and/or heating.

### CROSS-REFERENCE TO RELATED APPLICATIONS

The present application is a National Stage Application of PCT International Application No. PCT/FR2013/051257 (filed on Jun. 4, 2013), under 35 U.S.C. §371, which claims priority to French Patent Application No. A 1255175 (filed on Jun. 4, 2012), which are each hereby incorporated by reference in their respective entireties.

### TECHNICAL FIELD

Embodiments relate to a method of regulating an installation associating one (or several) cogeneration machines and one or several thermodynamic systems intended for air conditioning and/or heating. These thermodynamic systems are more commonly referred to as: air conditioner (whether or not reversible), water cooler or heat pump (whether or not reversible).

### BACKGROUND

There exists on the market so-called cogeneration machines that simultaneously produce electrical energy and heat. These cogeneration machines deliver, generally over an associated electrical network, a given electrical power. This electrical power is the main desired value to be respected by the machine when it is operating. The associated electrical network is most often a low-voltage network. When it is associated with a network of this type, the cogeneration machine operates in synchronized mode at 50 Hz (in Europe) or 60 Hz (“Synchrocoupling”). The peaks in electricity demand that are higher than the power that the machine is able to provide are absorbed by the associated electrical network. The thermal energy delivered by the cogeneration machine when it is operating depends on the desired electrical power. This thermal energy is sent to a heating network by the intermediary of a heat transfer fluid. When the thermal energy produced is greater than the heat requirement, the excess is evacuated by an external device (for example air coolers). When the thermal energy produced is less than the thermal requirement, a supplement is provided by another external device (for example a boiler). The generators of these cogeneration machines are usually conventional thermal engines (4-stroke mono- or multi-cylinder) connected to an alternator. Moreover, other types of generators are starting to appear such as for example fuel cells.

There exists on the other hand on the air conditioner market, water coolers and heat pumps (whether or not reversible) based on the thermodynamic cycle of cooling/heating by mechanical compression. The immense majority of these products use electrical energy (usually coming from the low-voltage network). This electrical energy is used by an engine & compressor unit often combined into a piece of equipment then called moto-compressor which transfers by the intermediary of a coolant fluid the heat from a source (for example the outside air, the heat coming from a geothermal probe or from a water table) to a load (for example the water of a heating circuit or domestic hot water). The thermal power transmitted to the source is the main desired value that the heat pump has to respect. The electrical power consumed by the heat pump is induced by this requirement of thermal power. The liaison is not entirely direct because phenomena such as the size of the compressor, the value of the inrush current, the operating conditions affect the instantaneous power demanded. The power available on the electrical network is rarely a problem as the electricity is produced by large-size plants (typically a gas turbine or nuclear plant), with centralized and permanent management of the energy.

Finally there exists installations that associate a cogeneration machine and a heat pump, such as is described, for example, in French Patent No. FR 2 927 161 and patent application WO 2011/01573 in the name of the applicant. In the devices of these documents, the cogeneration machine is more preferably not connected to the network, but can be connected to it optionally.

More precisely, French Patent No. FR 2 927 161 describes a multi-energy thermodynamic device for the simultaneous production of hot water, lukewarm water, cold water and of electricity, and more particularly a system or device comprising a heat pump actuated by an AC generator which allows for the simultaneous production of electricity, of hot water for example for heating buildings, of very hot water, for example domestic hot water, and of cold water, for example for air conditioning. The device described in this patent is an association of a cogeneration machine which is a combustion engine or a fuel cell, and a heat pump.

Patent application WO 2011/01573 relates to a system or device of modular design comprising at least one electric current generator module and one or several modules from among the following types: heat pumps, cooling or mixed heat pump/cooling modules, which allow for the simultaneous production of hot water for example for heating buildings, of very hot water, for example for domestic hot water, of cold water, for example for air conditioning, optionally coolant fluid typically for refrigeration and optionally for electricity.

In the installations described by the documents hereinabove, the desired value or values to be respected are desired thermal values, with the electricity being produced, in quality and in quantity, in a suitable manner to provide for the requirements of the compressor or compressors of the heat pump or pumps so that they transfer the required energy to the coolant fluid. The installation is managed by a control apparatus (“supervisor”) whether integrated or not into the installation comprising a hardware portion “commonly referred to as “hardware”) and an algorithm portion (commonly referred to as “software”),

The association of a cogeneration machine and of a heat pump is interesting as this makes it possible to share the thermal energies produced by each machine and this also makes it possible where applicable a “multi-energy” approach: electricity+fuel (natural gas or other: biogas, diesel, hydrogen, etc.). However the optimized implementation of these two technologies on the same application, on the same site, requires a method of management that can take into account the constraints linked to each machine, and as such allow for a global economic optimization of the system by measuring the energy consumption and production (thermal and electrical) by associating according to the rates in effect the opportunity of a strictly economic choice or linked to constraints with the source of energy available (type, for example natural gas and biogas and quantity).

### SUMMARY

A first purpose of embodiments is to provide a method of regulating an installation comprising one (or several) cogeneration machines and one or several thermodynamic systems (for example a heat pump) heat pump (and/or a refrigeration machine: air conditioner or water cooler).

Another purpose of embodiments is to provide a method of regulating an installation comprising a cogeneration machine and a heat pump (and/or a refrigeration machine), said cogeneration machine and heat pump not comprising sensors, hardware, or software allowing them to exchange information in order to operate between them in a suitable and optimized way.

Another purpose of embodiments is to allow for a simultaneous thermal and electrical optimization by taking into account the available energy sources and the costs of said sources.

These purposes are achieved thanks to a method of managing an installation comprising one or several cogeneration machines and one or several thermodynamic systems, such as heat pumps, as well as a computing machine, said method comprising the following steps: (a) Data called “base data” are entered into said computing machine, with said base data comprising at least the resilience to the electrical impact of the cogeneration machine, the value of maximum intensity of the heat pump; (b) Data called <<instantaneous data>> are entered into said computing machine, with said instantaneous data comprising at least the state of the cogenerating machine, the state of the heat pump and the electrical power demanded by the heat pump; (c) Data called “target data” are defined to which are assigned a respective “target value” in said computing machine, said target data comprising at least the minimum and/or maximum production of electricity by the installation, optionally the maximum consumption of electricity and of primary energy, and at least one from among: the temperatures of very hot water (T2), of hot water (T1), of cold water (T3), of evaporation of coolant fluid (T4, T5), and the electricity demand of the local network; and (d) the installation is regulated with the aid of said computing machine in such a way as to attain, for each piece of the target data selected, the target value or values which have been assigned thereto, with the regulation being performed by comparing the current value of the target data selected, by taking into account the base data selected as well as the instantaneous data selected, and by adjusting at least one piece of “adjustment data”, in such a way that the current value of each piece of target data selected is made to approach the target value assigned to it in step c), with the at least one piece of adjustment data comprising the electrical power provided by the cogeneration machine.

In other embodiments, at least one additional piece of “base data” of step (a) is selected in the group formed by (da1) the unit cost of the fuel of each combustion engine (2), fuel cell and absorption heat pump used in the system; (da2) the energy content of each fuel; (da3) CO2 impact of each fuel by unit of mass; (da4) the energy efficiency of each combustion engine (2) in accordance with its load and its speed of rotation, which makes it possible to determine the quantity of CO2 released per unit of mechanical power produced by this combustion engine (2); (da5) the nominal power at full load of each combustion engine (2) in accordance with its speed of rotation; (da6) the percentage of thermal power recovered on the cooling circuit of the combustion engine (2) and the percentage of thermal power recovered on the exhaust gases and/or the quantity of CO2 released per unit of thermal power produced by the combustion engine (2), (da7) the unit cost of the electrical energy provided by the external network; (da8) the service life of each generator in accordance with its load; (da9) the maintenance cost of each generator in accordance with the number of hours of operation; (da10) the cost of disassembling and replacing each generator; (da11) the service life, the cost of maintenance, the cost of disassembling and replacing each type of heat pump; (da12) the efficiency of the alternator in accordance with the electrical power that is provides, which makes it possible to determine the mechanical power demanded of the combustion engine (2) for an electrical power provided; (da13) the efficiency of the fuel cell in accordance with its load; (da14) the efficiency of the inverter of the fuel cell or of the photovoltaic solar panels when they exist; (da15) the electrical consumption and the flow rate of the circulation pump of the solar collectors; (da16) the unit sales price of the electrical energy provided to the external network.

In other embodiments, at least one additional piece of “instantaneous data” is selected in the group formed by: (db1) the instantaneous electrical power produced by each current generator present; (db2) the rotation speed of each combustion engine (2); (db3) the instantaneous consumption in fuel of the installation (1); (db4) the temperature of the fluid recovering the thermal energy of the combustion engine (2); (db5) the instantaneous electrical power consumed by the installation (1) with the network, obtained through a direct measurement; (db6) the instantaneous power provided to the network by the installation (1), obtained through a direct measurement; (db7) the current, the voltage or the instantaneous electrical power produced by the photovoltaic solar panel (if this panel is present); (db8) the instantaneous temperature T1; (db9) the instantaneous temperature T2; (db10) the instantaneous temperature T3; (db11) the instantaneous temperature T4 (db12) the instantaneous temperature T5 (db13) the temperature of the ambient air; (db14) the number of hours of operation of each electric current generator (mainly combustion engine 2 and fuel cell; (db15) the number of hours of operation of each heat pump circuit of the installation (vapor compression or absorption type).

In other embodiments, at least one additional piece of “target data” is selected in the group formed by: (dc1) the temperature T1 and its change in accordance with in particular the outside temperature; (dc2) the temperature T2 and its change in accordance with in particular of the outside temperature; (dc3) the temperature T3 and its change in accordance with in particular of the outside temperature; (dc4) the temperature T4 and its change according in particular to the temperature desired in the refrigerated space; (dc5) the temperature T5 and its change according in particular to the temperature desired in the refrigerated space (dc6) the global COP as being the maximum global COP for the installation (1) or the minimum global CO2 impact of the installation (1); (dc7) the energy cost as being the minimum energy cost of the installation (1); (dc8) the total operating cost as being the total minimum operating cost of the installation (1).

In other embodiments, at least one additional piece of “adjustment data” is selected in the group formed by: (dd1) the type, the number of current generators in operation, and the electrical power provided by each one of said generators; (dd2) the assigning of the electrical power provided by the generator or generators respectively to the installation and to the network external to the installation (1); (dd3) the type and the number of heat pumps in operation; (dd4) in the case of vapor compression heat pumps, the volumetric flow rate adjustment (expressed as a percent) imposed by the regulation on the compressors in order to optimize the installation (1).

The “current” value of the at least one piece of target data selected is determined from time to time or regularly or continuously.

The base data can be entered into the computing machine either when it is initially programmed, or when the installation is put into service, or by the user of the installation, over the course of time during the use of the installation.

In a particular embodiment, the method of regulating in accordance with embodiments further comprises the steps of: starting the cogeneration machine and starting the heat pump; controlling (i.e. limiting to a maximum value) the electrical power demanded by the heat pump, more preferably via an analog or all-or-nothing signal, in such a way as to prevent the cogeneration machine from overloading; commissioning and controlling pumps such as heating and air conditioning water pumps, domestic hot water pumps; commissioning and controlling hydraulic two- and three-way valves; and rendering adequate, by using modeling and control algorithms, the electricity requirement of the heat pump and of the production of electricity by the cogeneration machine, in such a way as to respect the desired values (target values) for thermal powers (hot water for heating, domestic hot water, cold air conditioning water, etc.), and optionally the desired value (target value) of electricity demand on the local network, while still obtaining a minimum resulting consumption of primary energy and of electricity.

In an embodiment, the controlling of the electrical power demanded by the heat pump can be obtained by limiting the slope of the loading of the output of water to the customer (typically in degrees/minute), i.e. by limiting the speed of the increase in temperature of the water of the heating circuit.

Calculating the adequacy involves the use of various parameters, which include parameters from medium outside of the machines, such as the temperature of the outside air, the date and time (in order to take the peak/off-peak rates into account for example), the limiting of the increase in temperature of the water, and parameters linked to the machines, such as information on the state of the pumps or of the valves. The results of the calculation produce the putting into service of various actuators (pumps, hydraulic valves).

In the framework of managing and optimizing the consumption of energy, the method of management in accordance with embodiments manages the type of energy consumed by the installation, in particular electricity and fossil energy such as natural gas, and optionally also biogas or fuel, hydrogen, the electrical network coming from renewable energy, taking into account the quantity demanded and the cost of this energy. The choice of the types of energy can be automatic for the purposes of a minimum instantaneous energy cost, or a minimum cost of possession that makes use of the cost of maintenance. This choice of the types of energy can also come from a calendar or from customer demand, or from the imposition locally or remotely from an intelligent network of the “Smart Grid” type.

Furthermore, in a particular embodiment, the method of management in accordance with this invention takes weather forecasts into account, in such a way as to manage the storage and the removal from storage of energy in accordance with the requirements. This storage can take place in the walls of the building to which the installation is associated, or in a dedicated thermal storage, such as, in a non-restricted manner, a water storage tank.

### DRAWINGS

FIGS. 1 and 2 respectively illustrate an installation regulated by the method in accordance with embodiments, in which:

FIG. 1 illustrates a block diagram of the installation regulated by the method in accordance with embodiments, in the case where the AC generator is a combustion engine connected to an alternator and the heat pump uses the vapor compression cooling cycle.

FIG. 2 illustrates a block diagram of the installation regulated by the method in accordance with embodiments, in the case where the AC generator is a combustion engine connected to an alternator and the heat pump uses the absorption cooling cycle.

### DESCRIPTION

In accordance with embodiments, a thermodynamic system of the heat pump or cooling type is a device comprising a compressor and several exchangers wherein a specific transfer fluid flows usually referred to as a coolant fluid, said device making it possible to absorb the thermal energy at a first temperature, and to restore thermal energy at a second temperature, with the second temperature being higher than the first.

In accordance with embodiments, a heat exchanger is a device intended to transfer heat between several circuits.

In accordance with embodiments, a transfer fluid is a heat transfer fluid used to transfer heat; the conventional examples are coolant fluid, water or glycol water sometimes referred to as brine.

In accordance with embodiments, a thermal source or source is by convention, the terms source and thermal load refer to the heating mode. The source is the medium from which the heat is extracted in heating mode. This extraction of heat takes place with certain physical characteristics such as thermal inertia or the available power that characterize the source. It can be noted that the term source is improper in cooling mode since heat coming from the building is in fact released therein.

In accordance with embodiments, a thermal load or load is the medium where the heat is released in heating mode. This heat rejection takes place with certain physical characteristics such as thermal inertia or the available power that characterize the load, likewise the load is the place where the heat is withdrawn in cooling mode.

In accordance with embodiments, COP or coefficient of performance of a system in heating mode is defined as the ratio between the heating power available over the electrical power consumed by the system. In the system in accordance with embodiments, “electrical equivalent” COP means the COP that the installation would have if electricity were used instead of gas or biofuel.

In accordance with embodiments, AC generator is a device that generates alternating current either directly or through the intermediary of an additional converter that transforms the direct current generated into alternating current.

In accordance with embodiments, a combustion engine is an engine that, via combustion, transforms the chemical energy contained in a fuel into mechanical energy.

In accordance with embodiments, an internal combustion engine is a combustion engine of which the combustion of the fuel producing the energy required for operation takes place in the engine itself, typically in a combustion chamber.

In accordance with embodiments, a photovoltaic solar panel is an electrical generator of direct current constituted of a set of photovoltaic cells connected to each other electrically.

In accordance with embodiments, a solar thermal collector is a device wherein the temperature of a solid, liquid or gas medium is increased by the total or partial absorption of solar radiation.

In accordance with embodiments, a fuel cell is a device that produces electricity thanks to an electrode of a reducing fuel (for example hydrogen) coupled to the reduction on the other electrode of an oxidant, such as the oxygen in the air.

In accordance with embodiments, a “Cogeneration” unit is a unit formed of one or several machines for cogeneration, comprising one or several electricity generator units of the thermal engine type+alternator and/or of the fuel cell type.

In accordance with embodiments, a heat pump shall refer to a set formed of one or several circuits, or even one or several heat pumps themselves provided with one or several circuits.

Embodiments described here relates to a method of management that makes it possible to optimize the operation of an installation provided with a cogeneration machine, which may or may not be able to be connected to the network and a heat pump. The electricity coming from the cogeneration machine is used in particular, but not exclusively, for supplying the heat pump. The main desired value to respect is the thermal requirement, i.e. the heating power, but also optionally the cooling power and/or an electrical power, demanded by the system.

A few moderated electrical power auxiliaries can be added to this unit in such a way as to ensure the proper operation of it. This is typically circulation water pipes, lighting.

This invention has for object a method of regulating an installation comprising at least one cogeneration machine and at least one heat pump.

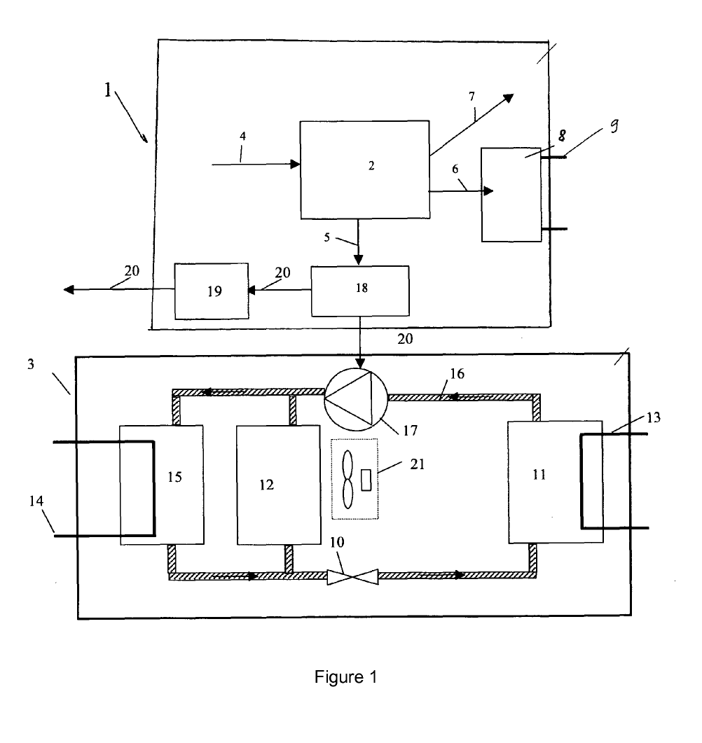

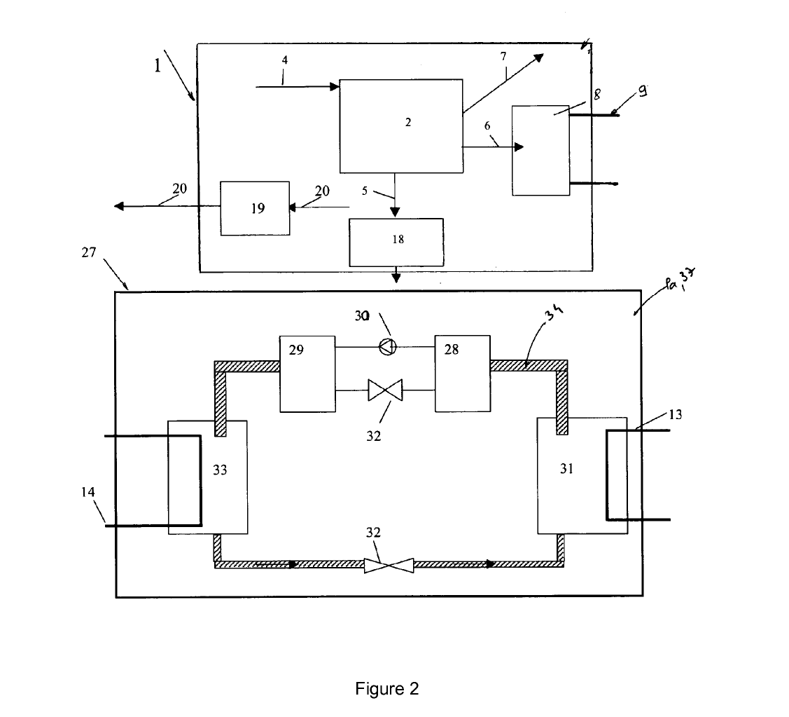

The installation to be regulated, described in reference to FIGS. 1 and 2, comprises at least one cogeneration machine comprising a current generator unit which comprises either a combustion engine (2) connected to an alternator (18) or a fuel cell. Each of the current generators comprises a heat exchanger (8) that produces very hot water at a temperature T2, said installation (1) or said current generator unit comprising, optionally, one or several other current generators, selected from the group constituted by a combustion engine (2) connected to an alternator (18), a fuel cell (not shown), a photovoltaic solar panel (not shown), or a wind turbine.

The installation to be regulated also optionally comprises an electrical accumulator (19). The installation to be regulated also comprises at least one heat pump (3), or a cooling unit, said heat pump or said cooling unit being either of the vapor compression type or of the absorption type.

When said heat pump or said cooling unit is of the vapor compression type it comprises at least one compressor (17) of coolant fluid, a first heat exchanger (11) located at the suction of the compressor (17) when the heat pump is in air conditioning mode, a pressure regulator (10), and a second heat exchanger (12) placed at the discharge of the compressor (17) when the heat pump is in air conditioning mode. Said heat pump or said cooling unit further optionally comprises a third heat exchanger (15).

When said heat pump or said cooling unit is of the absorption type, shown in FIG. 2, it then comprises an absorber (28), a circulation pump (30), a steam generator (29), a first heat exchanger (31) located at the inlet of said absorber (28), a pressure regulator (32) and a second heat exchanger (33) located at the outlet of said steam generator (29).

The compressor (17) or the circulation pump (30) is driven by an electric motor, which can be supplied by one of said current generators.

The installation to be regulated comprises at least one Pc Pa module referred to as “heat pump module” or at least one Pr module referred to as “refrigeration module” or at least one Pm module referred to as “mixed: heat pump and refrigeration.”

If this entails a heat pump module by compression Pc, each one of the at least one heat pump unit comprises at least one compressor (17) of coolant fluid, said first heat exchanger (11), said pressure regulator (10), said second heat exchanger (12).

If this entails a heat pump module by absorption Pa, each one of the at least one heat pump unit comprises at least one absorber (28), said circulation pump (30), said steam generator (29), said first heat exchanger (31), said pressure regulator (32) and said second heat exchanger (33);

If this entails a refrigeration module Pr, it comprises at least one cooling unit comprising at least one compressor (17) of coolant fluid, said pressure regulator (10), said second heat exchanger (12), as well as coolant fluid pipes (16a, 16b) intended to be connected to an air/water exchanger of coolant fluid external to the Pr module.

If this entails a mixed module Pm, it comprises at least two units one of the heat pump type and the other of the cooling type, where the unit of the heat pump type comprises at least one compressor (17) of coolant fluid, said first heat exchanger (11), said pressure regulator (10), said second heat exchanger (12), and the unit of the cooling type comprises at least one compressor (17) of coolant fluid, said pressure regulator (10), said second heat exchanger (12), as well as coolant fluid pipes (16a, 16b) intended to be connected to an air/water exchanger of coolant fluid external to the module Pm.

In an embodiment, the installation to be regulated allows for the simultaneous production of very hot water at a temperature T2, of hot water at a temperature T1 and/or of cold water at a temperature T3, and of electricity, and also optionally the production of coolant fluid at an evaporation temperature T4, and/or the production of coolant fluid at an evaporation temperature T5.

In an embodiment the cogeneration machine is a combustion engine, more preferably an internal combustion engine. It is supplied more preferably by natural gas. In accordance with the requirements, it can also be supplied by other gaseous or liquid fuels such as gasoline, fuel oil, kerosene, alcohol, biofuels such as vegetable oils, bioethanol, biogas. It can also entail other types of combustion engines, such as external combustion engines such as Stirling engines.

In another embodiment the cogeneration machine is a fuel cell. This can be any type of fuel cell known to those skilled in the art, operating typically, but not exclusively, at temperatures less than 200° C., but which can in certain cases reach a temperature from 800° C. to 1000° C. (for example a cell of the “solid oxide” type) and supplied by a suitable fuel, such as hydrogen, methane or a mixture of hydrocarbons such as gasoline or fuel. The fuel cell is comprised at least of one cell core supplied with hydrogen (the case with cores of fuel cells based on protonic membranes) or supplied by the plurality of fuels already mentioned (the case with high-temperature cell cores of the solid oxide type). If the cell is of the type based on protonic membranes and if the hydrogen is not directly available, then the fuel cell can be comprised of a reformer and of a cell core. The role of the reformer is to extract the hydrogen required for the cell core using more chemically complex fuels such as natural gas, methane, biogas or a mixture of hydrocarbons. The hydrogen extracted as such supplies the cell core based on protonic membranes.

In certain embodiments, the installation further comprises photovoltaic solar panels which can be any type of panel known to those skilled in the art, in particular, the semiconductor constituting the photovoltaic cells can be, in a non-restricted manner, amorphous silicon, polycrystalline or monocrystalline, a semiconductor organic material, or a combination of the latter. A plurality of photovoltaic solar panels can be used.

In preferred embodiments, the heat pump of the installation is reversible, which means that it can operate in a mode that favors heating (“heating mode”) or in a mode that favors cooling (“air conditioning mode”). To do this, a four-way cycle reversing valve 46 (FIG. 8c) is installed on the circuit of coolant fluid 16.

In the case where the heat pump 3 is reversible, the heat exchangers 11 and 12 are reversible exchangers.

The installation managed by the method in accordance with embodiments is furthermore controlled by at least one computing machine comprising at least one microprocessor and at least one data input interface. Data is entered into the microprocessor of said computing machine by the intermediary of said data input interface.

The computing machine that makes it possible to implement the method in accordance with embodiments comprises a regulating software that is based on a data input interface. It is furthermore connected with the required sensors, such as, but in a non-restricted manner, an outside temperature sensor, water outlet and inlet sensors, electrical power and/or intensity sensors, location sensors of the GPS type. Some of these sensors are present in the cogeneration machine and the heat pump by construction, other sensors are added in accordance with the requirements linked to implementing the method in accordance with embodiments. The computing machine also comprises if necessary electronic input/output boards, calculation boards, communication boards of the GPRS or Internet/Ethernet type.

Regulation

Generally, embodiments relate to a method for managing an installation comprising a cogeneration machine and a heat pump and a computing machine, said method comprising the following steps: (a) Data called “base data” art entered into said computing machine, said base data comprising at least the “resilience to electrical impact” of the cogeneration machine, the “Imax” of the heat pump; (b) Data called “instantaneous data” are entered into said computing machine, said instantaneous data comprising at least the state of the cogenerating machine, the state of the heat pump and the electrical power demanded by the heat pump; (c) Data called “target data” are defined to which are assigned a respective “target value” in said computing machine, said target data comprising at least the minimum consumption of primary energy and of electricity by the installation, and one from among: the temperatures T1, T2, T3, T4, T5, and the electricity demand of the local network; and (d) the installation is regulated with the aid of said computing machine is such a way as to attain, for each piece of the target data selected, the target value or values which have been assigned thereto, with the regulation being performed by comparing the current value of the piece of target data selected, by taking into account the base data selected as well as the instantaneous data selected, and by adjusting at least one piece of “adjustment data”, in such a way that the current value of each piece of target data selected is made to approach the target value assigned to it in step c), with the at least one piece of adjustment data comprising the electrical power provided by the cogeneration machine.

In other embodiments, at least one additional piece of “base data” of the step (a) is selected in the group formed by (da1)) the unit cost of the fuel of each combustion engine (2), fuel cell and absorption heat pump used in the system; (da2) the electrical content of each fuel; (da3) the CO2 impact of each fuel by unit of mass; (da4) the energy efficiency of each combustion engine (2) in accordance with its load and its speed of rotation, which makes it possible to determine the quantity of CO2 released per unit of mechanical power produced by this combustion engine (2); (da5) the nominal power at full load of each combustion engine (2) in accordance with its speed of rotation; (da6) the percentage of thermal power recovered on the cooling circuit of the combustion engine (2) and the percentage of thermal power recovered on the exhaust gases and/or the quantity of CO2 released per unit of thermal power produced by the combustion engine (2), (da7) the unit cost of the electrical energy provided by the external network; (da8) the service life of each generator in accordance with its load; (da9) the maintenance cost of each generator in accordance with the number of hours of operation; (da10) the cost of disassembling and replacing each generator; (da11) the service life, the cost of maintenance, the cost of disassembling and replacing each type of heat pump; (da12) the efficiency of the alternator in accordance with the electrical power that it provides, which makes it possible to determine the mechanical power demanded of the combustion engine (2) for an electrical power provided; (da13) the efficiency of the fuel cell in accordance with its load; (da14) the efficiency of the inverter of the fuel cell or of the photovoltaic solar panels when they exist; (da15) the electrical consumption and the flow rate of the circulation pump of the solar collectors; (da16) the unit sales price of the electrical energy provided to the external networks.

In other embodiments, at least one additional piece of “instantaneous data” is selected in the group formed by: (db1) the instantaneous electrical power produced by each current generator present; (db2) the rotation speed of each combustion engine (2); (db3) the instantaneous consumption in fuel of the installation (1); (db4) the temperature of the fluid recovering the thermal energy of the combustion engine (2); (db5) the instantaneous electrical power consumed by the installation (1) with the network, obtained through a direct measurement; (db6) the instantaneous power provided to the network by the installation (1), obtained through a direct measurement; (db7) the current, the voltage or the instantaneous electrical power produced by the photovoltaic solar panel (if this panel is present); (db8) the instantaneous temperature T1; (db9) the instantaneous temperature T2; (db10) the instantaneous temperature T3; (db11) the instantaneous temperature T4 (db12) the instantaneous temperature T5 (db13) the temperature of the ambient air; (db14) the number of hours of operation of each electric current generator (mainly combustion engine 2 and fuel cell; (db15) the number of hours of operation of each heat pump circuit of the installation (vapor compression type or absorption type).

In other embodiments, at least one additional piece of “target data” is selected in the group formed by: (dc1) the temperature T1 and its change in accordance with in particular the outside temperature; (dc2) the temperature T2 and its change in accordance with in particular the outside temperature; (dc3) the temperature T3 and its change in accordance with in particular the outside temperature; (dc4) the temperature T4 and its change in accordance with in particular the temperature desired in the desired in the refrigerated space; (dc5) the temperature T5 and its change according in particular to the temperature desired in the refrigerated space (dc6) the global COP as being the maximum global COP for the installation (1) or the minimum global CO2 impact of the installation (1); (dc7) the energy cost as being the minimum energy cost of the installation (1); (dc8) the total operating cost as being the total minimum operating cost of the installation (1).

In other embodiments, at least one additional piece of “adjustment data” is selected in the group formed by: (dd1) the type, the number of current generators in operation, and the electrical power provided by each of said generators; (dd2) the assigning of the electrical power provided by the generator or generators respectively to the installation and to the network external to the installation (1); (dd3) the type and the number of heat pumps in operation; (dd4) in the case of vapor compression heat pumps, the volumetric flow rate adjustment (expressed as a percent) imposed by the regulation on the compressors in order to optimize the installation (1).

The “current” value of the at least one piece of target data selected is determined from time to time or regularly or continuously.

In an advantageous embodiment, the tables of performances are entered for each type of heat pump giving the cooling power provided, the heating power provided, the electrical power consumed, the quantity of fuel consumed where applicable (case with the absorption heat pump) within its operating range. These performance tables are defined in fact by the water temperatures of each circuit (T1, T2 and T3, T4 and T5), the flow rate of the associated exchangers, and by the inlet temperature of the ambient air. The regulation mode can provide that any operation with one or several of these parameters outside if the defined operating range is prohibited.

In an advantageous embodiment, for each compressor used in vapor compression heat pumps, as an additional control, the following base data is entered: the tables of performance giving the cooling power provided; the heating power provided; and the electrical power consumed in accordance with the suction pressure and of the discharge pressure of the compressor for a given coolant fluid.

This data allows for an overlapping of the tables of performance hereinabove. It can also be used as base data in order to determine, for the full system, the cooling and heating power provided as well as the electrical power consumed by vapor compression heat pumps. This data integrates, for each compressor, the level of the volumetric flow rate (typically expressed as a percentage) at which it operates (typically from 10% to 100%).

The method of regulating of this invention makes it possible to optimize the combined operation of cogeneration machines and of thermodynamic systems for example of the type of heat pumps that can come from the market and come from different suppliers, which is not the case of the method described in patent application WO 2011/01573.

The method in accordance with this invention uses the same general principles as those described in patent application WO 2011/01573 but takes moreover particularly into account a larger quantity of technical characteristics of cogeneration machines (in terms of power and data available) and of thermodynamic systems (in particular the possibility of having different types of compressors that can be encountered on the market: fixed-speed compressor without power regulation, fixed-speed compressor but with power regulation, variable-speed compressor).

The method in accordance with embodiments must take into account the following characteristics of the cogeneration machine: state of the operating modes of the cogeneration machine: On, Off or fault; maximum power available in accordance with the outside temperature, the altitude and optionally other parameters linked to the engine; resilience to the electrical impact to a value of maximum intensity that it is possible to produce (Imax available in amperes), i.e. the capacity to hold an Imax available typically demanded by the heat pump, and optionally by a local electrical network, by providing a sufficient level of quality of the current (instantaneous frequency and voltage). The resilience to electrical impact generally characterizes the stability of an electrical system exposed to an increased instantaneous load (i.e. when the demand for current suddenly increases).

The method in accordance with embodiments must take into account the following characteristics of the heat pump: state of the operating modes: On, Off or fault; maximum value of intensity Imax demanded by the thermodynamic system. This value corresponds to the maximum sum of currents in the harshest conditions. This value is typically equal for a heat pump of n compressors to: Imax demanded by the thermodynamic system=Imax demanded by each compressor+starting current of the last compressor chosen as being the one of larger size; this value is proper to each heat pump, and is in accordance with the operating conditions and the size and type of the components, in particular the compressor.

The method in accordance with embodiments makes it possible to optimize the global operation of the installation. This optimization takes place over several aspects.

It first takes place on global efficiency, through the re-using of the heating power referred to as “fatal” on the generator but also through the optimization of the respective load of the generator or generators and of the load of the associated thermodynamic system or systems so that each one operates in the load range that provides a maximum associate global efficiency. The efficiencies of the gas-fueled thermal engines tend to increase with the load, those of compressors vary with the low and high pressure operating conditions but also in accordance with their speed of rotation by passing in this latter case by a maximum.

It takes place on the operation itself of the systems in different conditions in order to ensure that the generator will be able to resist without stalling or excessive slowing down to the impact of the electrical load of the compressors. It can also limit the demand of compressors in accordance with the capacity of the generator or generators. It also integrates degraded operating strategies that take into account the change in the thermal requirements and any limitations in performance of the generator or generators.

An advantage of the method of regulating in accordance with embodiments is to give to the installation that it regulates a flexibility for use. The flexibility for use constantly allows for the optimum choice of the type or types of energy used and/or provided, in accordance with external parameters and target parameters (objectives), subject to a suitable method of regulating.

The flexibility of use takes into account in particular the multiplicity of energies that can supply the various components of the system 1 in accordance with embodiments, as well as the multiplicity of the flows of energy that can be produced by the system 1. All of the modules hereinabove are supplied by one or several of the following energies: fossil fuels (in particular natural gas, liquefied petroleum gas, diesel, gasoline), biofuels, hydrogen and electrical current. Heat pumps modules can typically call upon the following two conventional cycles: the vapor mechanical compression cooling cycle and the absorption cycle. The conventional water networks connected to the heat pumps can be supplemented in the device by a water network coming from the thermal solar collectors. Electricity generating modules can call upon various technologies of the thermal engine and alternator, photovoltaic solar panel, wind turbine, turbine or fuel cell type.

The flexibility of use is made possible thanks to the global method of regulating the installation as a whole (heat pump and cogeneration machines) which allows for the optimum taking into account of the following target parameters among others (objectives):

(i) Priority given to the COP of the installation. Configurable coefficients make it possible to express the various energies outside of the device (for example the electricity of the network, the thermal energy of the solar collectors and the photovoltaic electric energy) in terms of primary energy and of the CO2 impact in order to provide a global view of the COP of the installation. The regulation takes into account in the global optimization the efficiency of the cogeneration machine. As such and among others operating rules: it is sought to operate the cogeneration machines in their maximum zone of efficiency (at full load for example for a thermal engine operating on natural gas); the maximum thermal discharge of the thermal engine is recovered. For example, if the requirements of the site for very hot water are less than the production of the thermal engine, this thermal production with hot water provided by the heat pump is accumulated; and it is sought to operate all of the heat pump modules with a partial load rather than stopping some of them in order to reduce the load on each exchanger and as such allow for more efficient operation from an energy standpoint.

(ii) Priority given to the energy operating cost of the installation. The approach is similar to the preceding optimization, but the configurable coefficients for each type of energy become the following: purchase cost of each energy outside of the device (typically electrical energy coming from the network or energy of the fossil fuel type or biogas) at the time of use. For example, the cost of the electrical energy can vary in accordance with the period of the year but can also vary in accordance with the consumption thresholds in the day or in the year, with this threshold or thresholds being linked to the electrical subscription of the installation in question. These weightings can of course change over the service life of the installation and can therefore be configured in the framework of the global method of regulating the device; this device can optionally have its economic parameters updated by a centralized system that integrates the location of the equipment as well as climate projections that allow for a global optimization of the system over time or to receive function impositions linked to one-off limitations of certain sources of energy; any resale price to the electrical energy network that can if necessary be produced by the cogeneration machine or machines. This price can also vary, in accordance with rules that are in general similar to those that apply to the purchase cost of electrical energy.

(iii) Priority given to the total operating cost of the installation (in particular the energy cost, the cost of maintenance which in particular includes the cost of disassembling and the cost of replacing). Particular importance is therefore given to the service life of certain critical components such as the combustion engines or fuel cells.

### LIST OF REFERENCE NUMERALS

1 Installation regulated by the method in accordance with embodiments
2 Combustion engine
3 Heat pump
4 Liquid or gaseous fuel inlet
5 Mechanical energy produced by the engine
6 Heat emitted by the AC generator in operation
7 Energy losses
8 Heat exchanger for exchanging heat between AC generator and very hot water
9 Very hot water circuit
10 Pressure regulator
11 Reversible heat exchanger—Condenser in heating mode, exchanger on the load in heating mode
12 Reversible heat exchanger—Evaporator in heating mode, exchanger on the source of heat in heating mode
13 Water circuit—cold water circuit when the heat pump is in air conditioning mode
14 Hot water circuit
15 Heat exchanger
16 Coolant fluid circuit
17 Compressor
18 Alternator
19 Electrical accumulator
20 Electrical energy
21 Motorized fan
24 DC/AC converter
27 Heat pump using the cycle by absorption
28 Absorber
29 Generator
30 Circulation pump
31 Evaporator of the absorption cycle
32 Pressure regulator adapted to the absorption cycle
33 Condenser of the absorption cycle
34 Coolant fluid
35 Absorber

1-7. (canceled)

8. A method for managing an installation of at least one cogeneration machine, at least one thermodynamic system, and at least one computing machine, the method comprising:
entering base data into the computing machine, the base data including at least a resilience to an electrical impact of the at least one cogeneration machine, and a value of maximum intensity of the at least one thermodynamic system;
entering instantaneous data into the computing machine, the instantaneous data including at least a state of the installation of the at least one cogeneration machine, the at least one thermodynamic system, and an electrical power demanded by the at least one thermodynamic system;
defining target data to which are assigned a respective target value in the computing machine, the target data including one of: (i) at least a minimum and/or a maximum production of electricity by the installation; and (ii) a maximum consumption of electricity and primary energy, and at least one of: temperature values of water at a first temperature (T2), water at a second temperature (T1), water at a third temperature (T3), and an evaporation of coolant fluid at a fourth temperature T4 and a fifth temperature (T5), and the electricity demand of the local network, wherein T2>T1 and T1>T3;
regulating the installation via the computing machine in such a way as to attain, for each piece of target data selected, at least one target value which has been assigned thereto, the regulating including comparing a current value of a selected target data, by taking into account the base data selected and the instantaneous data selected, and adjusting at least one adjustment data in such a way as to approach the current value of each target data selected of the target value assigned to it, with the at least one adjustment data including the electrical power provided by the cogeneration machine.

9. The method of claim 8, wherein at least one additional base data of is selected from one of:
a unit cost of fuel of a combustion engine for the at least one cogeneration machine, a fuel cell and an absorption heat pump used in the at least one thermodynamic system;
an energy content of the fuel;
a CO₂ impact of the fuel by unit of mass; and
an energy efficiency of the combustion engine in accordance with its load and speed of rotation, to thereby determine a quantity of CO₂ released per unit of mechanical power produced by the combustion engine.

10. The method of claim 9, wherein the at least one additional base data of is also selected from one of:
a nominal power at full load of the combustion engine in accordance with its speed of rotation;
a percentage of thermal power recovered on a cooling circuit of the combustion engine and a percentage of thermal power recovered on exhaust gases and/or the quantity of CO₂ released per unit of thermal power produced by the combustion engine;
a unit cost of electrical energy provided by an external network; and
a service life of a generator in accordance with its load.

11. The method of claim 10, wherein the at least one additional base data of is also selected from one of:
a maintenance cost for the generator in accordance with a number of hours of operation of the generator;
a cost of disassembling and replacing the generator;
a service life, cost of maintenance, cost of disassembling and cost of replacing each type of heat pump of the at least one thermodynamic system; and
an efficiency of an alternator of the at least one cogeneration machine in accordance with an electrical power provided by the alternator, to thereby determine a mechanical power demanded of the combustion engine for an electrical power provided.

12. The method of claim 11, wherein the at least one additional base data of is also selected from one of:
an efficiency of the fuel cell in accordance with its load;
an efficiency of an inverter of the fuel cell, or the efficiency of photovoltaic solar panels of the installation;
an electrical consumption and a flow rate of a circulation pump of the photovoltaic solar panels; and
a unit sales price of the electrical energy provided to the external network.

13. The method of claim 8, wherein at least one additional instantaneous data is selected from one of:
an instantaneous electrical power produced by a generator of the at least one cogeneration machine;
a rotation speed of the combustion engine;
an instantaneous consumption in fuel of the installation;
a temperature of fluid recovering the thermal energy of the combustion engine; and
an instantaneous electrical power consumed by the installation with an external network, obtained through a direct measurement.

14. The method of claim 13, wherein at least one additional instantaneous data is selected from one of:
an instantaneous power provided to the external network by the installation, obtained through a direct measurement;
the current, the voltage or the instantaneous electrical power produced by photovoltaic solar panels of the installation;
an instantaneous value of the first temperature T1;
an instantaneous value of the second temperature T2; and
an instantaneous value of the third temperature T3.

15. The method of claim 14, wherein at least one additional instantaneous data is selected from one of:
an instantaneous value of the fourth temperature T4;
an instantaneous value of the fifth temperature T5;
an instantaneous value of the temperature of the ambient air;
a number of operating hours of the combustion engine and the fuel cell; and
a number of operating hours of each heat pump circuit of the installation.

16. The method of claim 8, wherein at least one additional target data is selected from one of:
the first temperature T1 and its change according to an outside temperature;
the second temperature T2 and its change according to the outside temperature;
the third temperature T3 and its change according to the outside temperature;
the temperature T4 and its change according to in particular the temperature desired in the refrigerated space; and
the fifth temperature T5 and its change according to a temperature desired in a refrigerated space.

17. The method of claim 16, wherein the at least one additional target data is also selected from one of:
a global coefficient of performance as being a maximum global coefficient of performance for the installation, or the minimum global CO₂ impact of the installation;
an energy cost as being a minimum energy cost of the installation; and
a total operating cost as being a total minimum operating cost of the installation.

18. The method of claim 8, wherein at least one additional piece of adjustment data is selected from one of:
a type and number of generators of the at least one cogeneration machine in operation, and an electrical power provided by each generator; and
an assigning of an electrical power provided by each generator to the installation and to an external network.

19. The method of claim 18, wherein the at least one additional piece of adjustment data is also selected from one of:
a type and number of heat pumps of the at least one thermodynamic system in operation; and
in a case of vapor compression heat pumps, a volumetric flow rate adjustment (expressed as a percent) imposed by regulation on compressor of the at least one thermodynamic system in order to optimize the installation.

20. The method of claim 8, wherein the current value of the at least one target data selected is determined intermittently.

21. The method of claim 8, wherein the current value of the at least one target data selected is determined regularly.

22. The method of claim 8, wherein the current value of the at least one target data selected is determined continuously.

23. The method of claim 8, wherein the base data is entered into the computing machine when it is initially programmed over a course of time during use of the installation.

24. The method of claim 8, wherein the base data is entered into the computing machine by the user of the installation, over the course of time during the use of the installation.

25. The method of claim 8, wherein the base data is entered into the computing machine when the installation is put into service, over the course of time during the use of the installation.
